(19) United States
(12) Patent Application Publication
(10) Pub. No.: US 2016/0294781 A1
(43) Pub. Date: Oct. 6, 2016

(54) PARTIAL OR COMPLETE IMAGE OBFUSCATION AND RECOVERY FOR PRIVACY PROTECTION

(71) Applicants: Jennifer Kate Ninan, San Jose, CA (US); Ajit Ninan, San Jose, CA (US)

(72) Inventors: Jennifer Kate Ninan, San Jose, CA (US); Ajit Ninan, San Jose, CA (US)

(21) Appl. No.: 14/604,728

(22) Filed: Jan. 25, 2015

(51) Int. Cl. H04L 29/06; G06F 21/62; G06K 9/00; G06T 7/00; G06T 5/00

(52) U.S. Cl. CPC H04L 63/0407; G06T 7/0081; G06T 5/002; G06K 9/00228; H04L 63/06; H04L 63/0428; G06F 21/6245; G06F 21/62

(57) ABSTRACT

A system described herein pertains to privacy protection of personal images online and in particular within social media networks. A method consistent with the present disclosure includes capturing an image within computer memory. After the image is captured, analyzing the image and segmenting the image. Segmenting the image may include modifying the captured image into a modified image. The modified image includes an obfuscated portion.

### TECHNICAL FIELD

The invention relates to still images and moving images and the privacy & protection issues related to it. The invention has applications, for example, in rendering of images for viewing and sharing via any network and social distribution networks and other image or video sharing mechanisms.

### BACKGROUND

Sharing of images and videos have become widespread on social networks, image repositories, websites and other network sharing mechanisms. The issue of privacy has become an issue due to these sharing networks where people are connected via complicated sharing graphs which cause shared data such as images and video to be touched by common friends or entities or machine learning robots and become available to extended nodes of that social network without the explicit permission of people involved in the image or video and private data such as faces, likenesses, objects, location, GPS info, and in general recognizable items that can be considered private to an individual may be shared across unintended nodes of an extended social graph.

Due to the privacy of one individual and their concern for their privacy a picture or video may become restricted to other users in the social graph. There may be others in the picture that has friends that are not connected to the privacy concerned individual that would like to see the same picture. Today the existing imaging systems are not capable of fixing this problem thereby leaving a situation of no privacy or complete privacy and nothing in between.

### SUMMARY OF THE INVENTION

This invention allows for extended social graphs and Computer Vision (CV) robots extracting information to view an image but yet preserve and protect the privacy and information of individuals that may be in the image. The unconnected individuals or CV Robots will be able to view an image however the protected individual's information is obfuscated. The image areas that relate to the individual's information is obfuscated so unconnected or unrelated individuals or do not have permissions to view it. However, a permissioned user will be able to see the complete image using the same shared package. This is not limited to just the facial likeness but also includes all data considered under privacy such as image data, image location, documents, metadata location, etc. This is useful to protect privacy against human viewing and machine vision learning and recognition.

One embodiment of the image can be done such that the image is broken up into a plurality of pieces. The backward compatible base layer that everyone will be able to see and considered the common non-private part of the image. This image will have all individual's faces and privacy related data obfuscated by some existing means described by other existing literature. The mechanisms to identify are described extensively by literature today. Some mechanisms to obfuscate include adding different blur techniques, quantized pixelating or using black box insertion done manually or automatically. This processed image will be viewable by all as is done by a typical digital image or video today shared in JPEG, TIFF or other such file format today. The system will work for video formats such as but not limited to MPEG4, HEVC, H264, VC1 and other video compression formats and include still imaging formats such as JPEG, TIFF, Exif, RAW, PNG, GIF, BMP, WEBP, PPM, PGM, PBM, PNM and other still imaging compression formats. All these formats have a mechanism to transfer metadata and layer the data. This layering and metadata mechanism is leveraged to obfuscate and layer the missing data in these signaling mechanisms.

The obfuscated parts of the image will be segmented and the original data for each of these obfuscated segments will be stored separately after being encrypted with a key. This data is protected such that only a decoder with the appropriate key will be able to unlock this obfuscated part of the image and overlay it onto the picture to recreate the image. The key will be distributed to friends in an appropriate way at decode time or at any time the system sees optimal thereby allowing a face that is obfuscated to be able to be viewed by approved friends only while obfuscating the parts of the image that the user is not approved for. This way the complete image is not restricted and the complete image is not viewable but rather the privacy information of individuals who are not part of a social network is protected.

### BRIEF DESCRIPTION OF THE DRAWINGS

The accompanying drawings illustrate non-limiting embodiments.

FIG. 1 is a flow diagram of a possible embodiment of an encoder system consistent with the present invention to encode an image.

FIG. 2 is an exemplary illustration of an image with privacy data associated with three users.

FIG. 3 is an exemplary illustration of an image container which includes a base backward compatible layer and a metadata layer.

FIG. 4 is an exemplary social graph and approved friend list for two users.

FIG. 5 is a legacy backward compatible pipeline to decode a modified image and a plurality of privacy data associated with an original image.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

This invention provides for a mechanism capable of being able to protect privacy for individuals in images and video from others in a social network graph that an individual may not be directly connected to but indirectly connected to. This is not restricted to network sites but requires a validation scheme and a distribution of keys to a decoder. [ ] It allows for others in the image or video to be viewed by other connected individuals thereby not restricting the entire image to a very small subset of all common people in the picture.

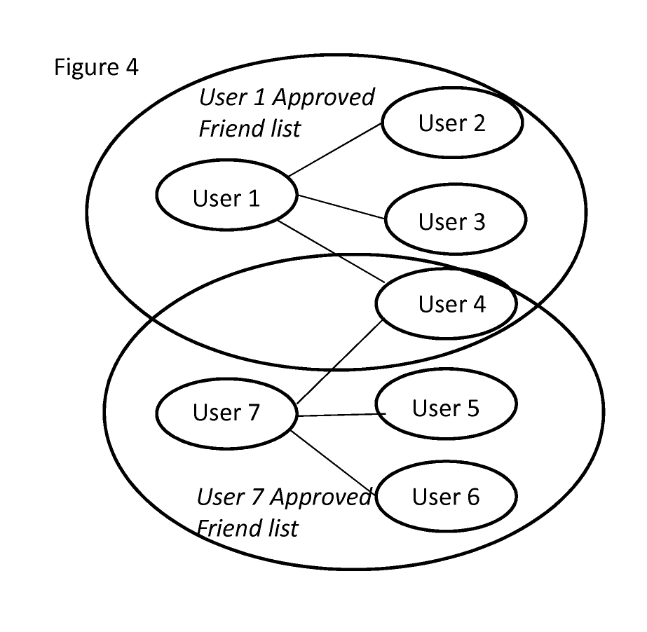

FIG. 4 described a user list and a connected social graph. This shows that User 1 is connected and has on his approved friends list User 2, User 3, User 4. At the same time User 7 has friends User 4, User 5, User 6, User 7 and User 1 have in common User 4.

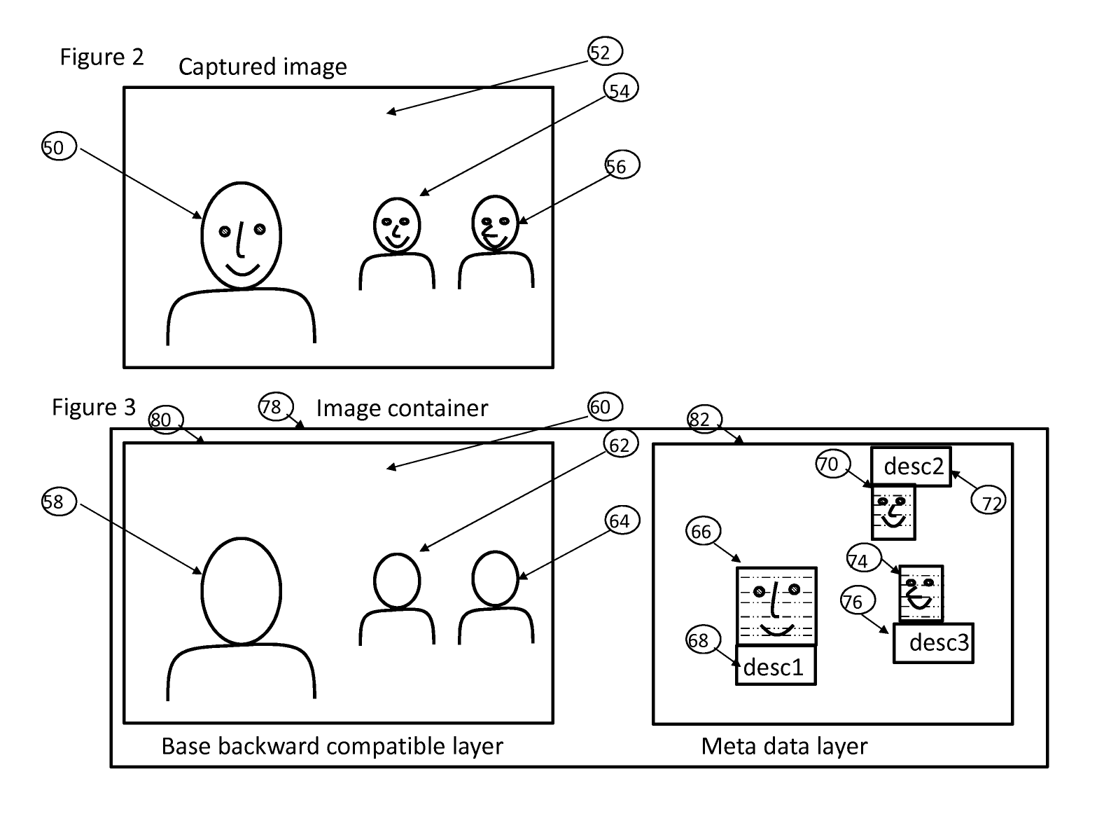

As an example as shown in FIG. 2 a picture taken with User 3 50, User 4 54 and User 5 56 with common background and other information 52 is shared. As described in FIG. 4 since User 4 is common typically what will happen is that User 1 and User 7 will be able to see this picture. Today both User 1 and User 7 will see the private information of User 3, User 4 and User 5.

Ideally in FIG. 4 User 7 will only be able to see FIG. 2's captured image areas that he has connections to which is User 4 and User 5's data which in FIG. 2 is User 4 54, User 5 56 along with information 52 that is common non private data while obfuscating User 5's 50 image which is the private data of User 3 since User 7 does not have User 3 in his social network and or list of approved friends. Similarly User 1 should be able to see User 3 and User 4 but not User 5 as described by the social graph in the FIG. 2.

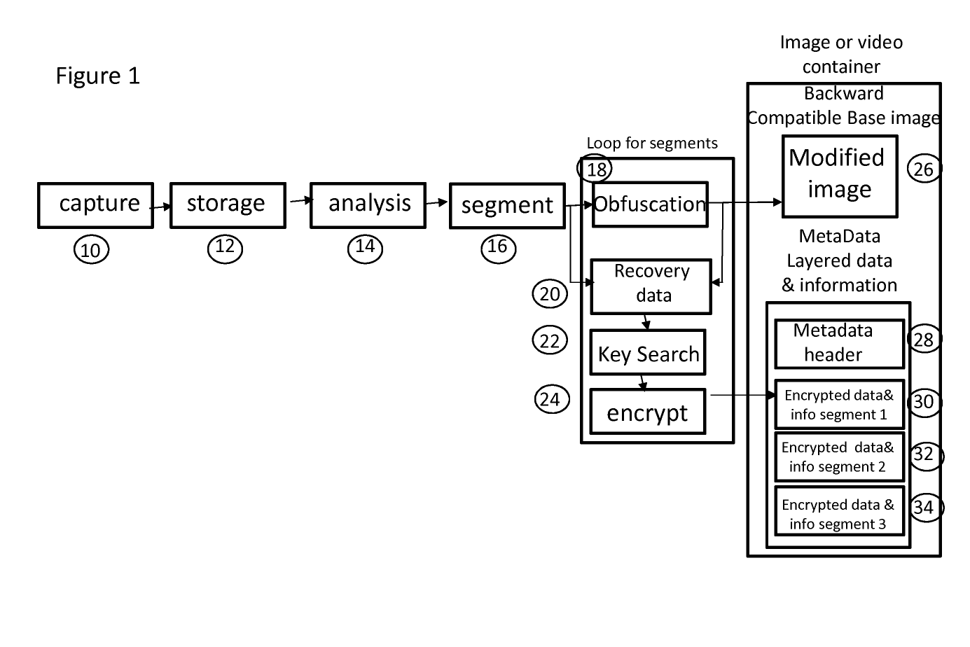

FIG. 1 shows one embodiment of how this system can be achieved to encode a picture. The image is first captured (step 10) and stored (step 12), the image can be analysed (step 14) first and then stored but in this example it is analysed (step 14) in the cloud after storage. The analysis (step 14) can be automated or manual such as tagging or painting over by a concerned user. The automated mechanisms are many today and range from mechanisms such as face recognition object recognition and augmented reality type tools detecting location identifiers as example. This will result in privacy data being identified for obfuscation. The region to be obfuscated and the mechanisms vary from automated to manual systems but the image regions are now segmented (step 16). The image may be segmented into multiple regions or shapes. For each region or shape a loop is run as described in FIG. 1 for steps 18, 20, 22, 24.

The first segment identified is then obfuscated (step 18) by a selected mechanism. This mechanism may range from algorithm that will change the facial characteristics such as eye distance, nose length, skin colour change etc or simple add in of motion blur type characteristic that makes the face unrecognizable are examples of methods used and are extensively discussed in other literature. Some of the mechanisms can be as simple as a user painting over the face or a simple box tag. Once this segmented area is modified the output of (step 18) which is the modified data along with the original data which is the output of the segmentation block (step 16) is fed to (step 20) the Recovery data calculation block. This is simply using the original and the modified data to come up with a mechanism to come up with data that can allow us to recover the obfuscation that is created.

In one embodiment it may be as simple as a difference signal of the RBB or YCrCb from the original to the modified or it could be just the original as an overlay and be signaled in the header as an overlay type recover data rather than a calculated difference between the two inputs, linear or nonlinear. The recovery data can then be fed to the key search (step 20).

The key search (step 20) is simply a mechanism used to find an appropriate key to encrypt the data. The requirements for this key are not limited to being a public key type encryption but mostly needs to be a key that is associated with the private data owner. An example is in FIG. 2 User 3 50 facial features belongs User 3 and the key should be determined such that User 3 approves any decrypting the decoding process of User 3's 50 image in FIG. 2. This can be done by a simple key exchange and data exchange of keys in a secure handshake protocol between servers or databases or that will allow the viewer such as User 1 from FIG. 4 to get User 3's data after authenticating that he is part of the approved friends list. In certain systems, the actual segmented private data could reside as part of User's 3 database for that specific image and upon getting an image ID and segment ID, the segment can be exchanged via a secure link to the decoder.

In one embodiment, the key that has been determined to be used can be passed to the Encryption engine (step 24). This encrypted data along with its information such as xy location of where in the image this piece of data should be decoded over to recover information will be stored as part of encrypted data 30, 32, 34 on a per segment basis (segments 1, 2, & 3). The Metadata header 28 will create the final description of a code stream for all the metadata layered information for partial or complete image obfuscation recovery via multiple encryption keys per segment. The original image that has been modified by obfuscation is stored as the backward compatible base layer image/legacy image or video shown as modified image 26.

The complete image container will have the backward compatible/legacy layer that every decoder will be able to read today and this layer will be viewable by all. The legacy decoders will be able to read today and this layer will be viewable by all. The legacy decoders will not understand the metadata obfuscation layer since it will be hidden as application layer data or stored in any area of the container that a legacy decoder will ignore. The legacy decoder will ignore this data. Thereby protecting and creating privacy for all involved in the image or video. The advanced social network applications can use the metadata obfuscation layer to determine who can see the obfuscation segments via a key exchange or data exchange mechanism and the rendering agent can recover the appropriate data.

FIG. 3 shows the image container 78 with the base backward compatible obfuscated layer 80 with all privacy data stripped. The meta data layer or the obfuscation recovery layer 82 has the 3 segments that are obfuscated from FIG. 2's Captured image. FIG. 2's User 3 50 image become obfuscated to FIG. 3's obscured image 58 and the obfuscation recovery information is encrypted and described by image 66 as encrypted data. This is only decodable by an exchanged key or exchanged data mechanism that could be described by meta data 68 along with xy location information, segment id and user key and user server information and such. The desc1 will have all information necessary to ensure that if the viewer has permissions to reconstruct the obfuscated for FIG. 2's User 3 50 image that have been hidden by obscured image 58 it will be exchanged in a secure manner.

The same is true for all the segments, FIG. 2's User 4 54 image as it relates to FIG. 3's 62 obscured image, recovery data 70 and meta data 72. Finally as FIG. 2's User 5 56 image and FIG. 3's obscured image 64, recovery data 74, meta data 76.

In a typical system it is better to store the encrypted data in the image container, however once the key has been handed to the viewer the rights for that specific image cannot be revoked. The advantage of a system where the obfuscated data sits on a server tied to the user who own the data is that if a user unfriends someone that data becomes unavailable to that unfriended viewer. The other mechanism that is involved in the encryption key is that the owner may have a single key or multiple keys. A single key becomes less reliable because once that key is compromised then that user can be decoded always for any image. It is better for the key exchange to be unique to that image and segment by a key hash based on the image and segment information along with the user's key and or some random seed stored for that image at the privacy owner's database.

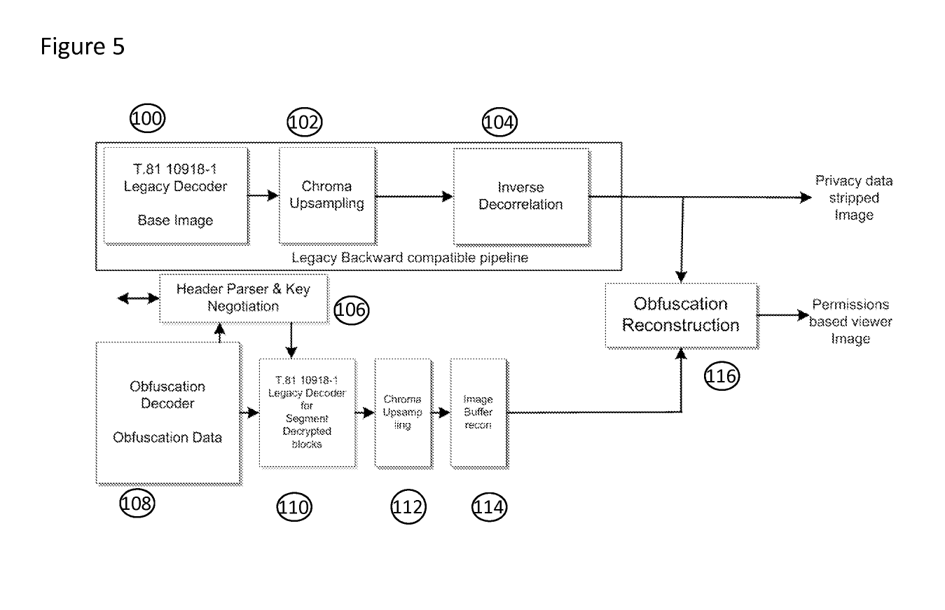

FIG. 5 represents decoder architecture specifically for JPEG, this embodiment exemplifies the implementation for still images but is not limited to JPEG or still images. The concept works for video and other still image and video formats. The architecture explains the layered approach for obfuscation and segmented image approach for selective encryption and decryption and decode base on permissions. In this embodiment in FIG. 5 block 100,102,104 show the legacy backward compatible pipeline that outputs a privacy data stripped image as described earlier. The lower pat starting with block 108 which is the metadata is first parsed by block 106 and the key are negotiated by an external entity and the decryption mechanism is passed to block 106. The data in block 108 may be stored in JPEG box format or any header format that fits as meta data without impeding legacy decoding, the data stored in the meta definitions are based on parameters and segments mentioned in this application. The encryption key information is then sent to the decryption block for the code stream in block 110 and then uses the 10918-1. JPEG decoder or some compression mechanism to decode the decrypted block of compressed image data. This encryption decryption at the code stream level for the block is one embodiment and could be done at the image level as well. This step could be bypassed and the uncompressed data may be used as well. In the case of compressed data block 110 then follows up with standard JPEG decoding to choma upsample in block 112 and the decoded obfuscation recovery block data is put in an image buffer in block 114 to reconstruct the image.

The block data uses the x,y and height and width parameters in the header to position it such that it sits in the image buffer corresponding to the pixel location of the original image in the upper path that needs to the recovered by this corresponding pixel data. Once all the blocks are either decoded by the decryption and placed in the image buffer if there are blocks that cannot be decrypted they are skipped over and replaced with values in the image buffer that represent no affect or a transparency so that the original data will pass through. The original image from block 104 is then fed to the Obfuscation reconstruction block 116 along with the obfuscation recovery data from block 114. This data is then recovered based on the image buffer regarding if there is data to be replaced or recovered based on the obfuscation type.

The final data is the reconstructed data that is based on the permissions for that viewer and is a either a completely reconstructed image or a partially reconstructed image with some obfuscation. The image data seen will be data that the viewer is privileged to see based on his relationship to the owners of the sub data structures in the image.

This description of the system may be embodied in software implementation on a PC, embedded system or such processor, DSP based systems or as hardware cores directly to transistors and logic and portioned into multiple chips onto a PCB design. It is not limited by these implementations but these are some of the embodiments of this system.

What is claimed:

1-18. (canceled)

19. A method, comprising:
capturing an image;
analyzing the captured image; and
segmenting the captured image into a plurality of regions,
wherein segmenting the captured image includes modifying the captured image such that the modified image includes a modified portion of the captured image;
wherein the modified image includes an obfuscated portion;
wherein the obfuscated portion is recoverable.

20. The method of claim 19, wherein segmenting the captured image further includes:
storing the modified image;
generating recovery data to reproduce the obfuscated portion of the captured image; and
storing the recovery data.

21. The method of claim 20 further comprising utilizing a first key to encrypt the modified image.

22. The method of claim 20, wherein the modified image is stored in a compressed format.

23. The method of claim 20 further comprising utilizing a second key to encrypt the recovery data.

24. The method of claim 20, wherein modifying the captured image includes at least one of adding a blur effect to the obfuscated portion and changing characteristics of a face captured in the image.

25. The method of claim 19 further comprising using object recognition means to identify privacy data; wherein the privacy data is subsequently obfuscated within the modified image.

26. The method of claim 25, wherein the object recognition means includes a facial recognition means.

27. A digital file stored on a computer readable medium, the digital file comprising an image file or video file format comprising:
a first data block, wherein the first data block includes an identifier to at least one obfuscated recovery data; and
a second data block, wherein the second data block includes an obfuscated image data.

28. The computer readable medium of claim 27, wherein the image file or video file format includes at least one of JPEG, TIFF, MPEG4, HEVC, H264, VC1, Exif, RAW, PNG, GIF, BMF, WEBP, PPM, PGM, PBM, and PNM.

29. The computer readable medium of claim 27, wherein the first data block further includes location data of where the encrypted data should be placed on the obfuscated image data during a decode process, data descriptions pertaining to at least one of the height, width, shape, obfuscation method, image owner, or lookup information regarding the manner to decode or decrypt the at least one encrypted data.

30. The computer readable medium of claim 27, wherein the image file format is backwards compatible with legacy-based decoders which are incapable of accessing the first data block.

31. The computer readable medium of claim 27, wherein the obfuscated portion of the obfuscated image data includes an overlay as a transparency, alpha blend, multiplicative, or additive.

32. A computer-implemented method of providing a service over a networked server system for access rights to privacy data within media from users of the service, the service provided using a networked server system comprising at least one processor or at least one memory, the method comprising:
(a) storing a media file associated with a first user, wherein the media file includes privacy data associated with the first user and a second user;
wherein the first user and the second user each has access rights to the privacy data associated with each other;
(b) determining whether a third user has access rights to the privacy data of one of the first user or the second user;
(c) when the third user has access rights to the privacy data of one of the first user or the second user, but not both, providing access rights to the media file without access rights to the privacy data of the first user or the second user of whom the third user does not have access rights to such privacy data.

33. The computer-implemented method of claim 32, wherein the privacy data associated with the first user includes a first facial image of the first user and the privacy data associated with the second user includes a second facial image of the second user.

34. The computer-implemented method of claim 32, wherein the media file includes still image data or video data.

35. The computer-implemented method of claim 34, wherein the still image data or video data includes a privacy data associated with the first user and the second user.

36. The computer-implemented method of claim 32, wherein providing access rights to the media file without access rights to the privacy data associated with the first user or the second user of whom the third user does not have access to such privacy data includes providing the media file with the privacy data obfuscated.

37. The computer-implemented method of clam 32 further comprising establishing an access relationship between the third user and the first user or the second user of whom the third user did not have access rights to such data, wherein such access relationship between the third user and said first user or said second user provides access rights to the media file with the privacy data associated with said first user or said second user of which was previously obfuscated.

38. The computer-implemented method of claim 32, wherein the first user and the second user each has access rights to view the data associated with each other via an exchange of privacy keys which are associated with the first user and the second user; wherein a first privacy key set associated with the first user allows access rights to the privacy data associated with the first user and a second privacy key set associated with the second user allows access rights to the privacy data associated with the second user; and wherein when the third user does not have access rights to one of the privacy data associated with the first user or the second user, the third user does not have said first privacy key set associated with said first user or the second privacy key set associated with said second user.
